(19) United States
(12) Patent Application Publication
(10) Pub. No.: US 2026/0054883 A1
(43) Pub. Date: Feb. 26, 2026

(54) Tool Container System

(71) Applicant: Yantai Greenery Tools Co., Ltd., Yantai (CN)

(72) Inventors: Changlei FAN, Yantai (CN); Caiyun YAO, Yantai (CN); Bo YU, Yantai (CN)

(21) Appl. No.: 19/266,762

(22) Filed: Jul. 11, 2025

(30) Foreign Application Priority Data
Aug. 23, 2024 (CN) 202422054114.6

(51) Int. Cl. B65D 21/02; B25H 3/02

(52) U.S. Cl. CPC B65D 21/0223; B25H 3/02

(57) ABSTRACT

Provided is a tool container system. The tool container system includes a first tool container and a second tool container that can be stacked. The first tool container is provided with a first locking part, the second tool container is provided with a second locking part matched with the first locking part, the first locking part is slidably connected to the first tool container, and the first locking part is accommodated in the first tool container at an accommodating position. When the second tool container is stacked on the first tool container, or when the first tool container is stacked on the second tool container, the first locking part is pulled out of the accommodating position and then turned over to a side where the second tool container is located, and the first locking part is turned over to the second locking part and locked to the second locking part.

### CROSS-REFERENCE TO RELATED APPLICATIONS

The present disclosure claims the priority of Chinese Application No. 202422054114.6, filed on the Chinese Patent Office on Aug. 23, 2024, and entitled “Tool Container System”.

### TECHNICAL FIELD

Embodiments of the disclosure relate to the technical field of containers for accommodating objects, and particularly relate to a tool container system.

### BACKGROUND OF THE INVENTION

A tool container system is a box for storing tools with different functions. It is a container for storing various tools and household sundries, which can be widely used for production, household chores, maintenance, fishing and other purposes.

In the related art, tool container systems are generally stacked to save space. Moreover, in order to prevent a tool container system located at an upper layer from falling and conveniently transport the stacked tool container systems together, a connection locking structure is arranged between stacked objects. In the related art, the connection locking structure generally includes a first locking buckle arranged on a first tool container system and a second locking bayonet arranged on a second tool container system. When not in use, the first locking buckle generally lies flat on a cover of the first tool container system. When the second tool container system needs to be stacked on the first tool container system, the first locking buckle is turned over, and then the second tool container system is stacked on the first tool container system.

However, when the second tool container system is stacked on the first tool container system, a problem of inconvenient stacking is caused.

### SUMMARY OF THE INVENTION

Embodiments of the disclosure provide a tool container system, so as to solve a technical problem of inconvenient stacking when a second tool container system is stacked on a first tool container system.

To solve the above technical problem, the embodiments of the disclosure provide the following technical solution:

An embodiment of the disclosure provides a tool container system. The tool container system includes a first tool container and a second tool container.

The first tool container is provided with at least two first locking parts. In all the first locking parts, at least one of the at least two first locking parts is arranged at a first side of the first tool container, at least one of the at least two first locking parts is arranged at a second side of the first tool container, and the first side and the second side are two opposite sides of the first tool container. In any one of the at least two first locking parts, each of the first locking parts is slidably connected to the first tool container, and the each of the first locking parts is at least capable of sliding between an accommodating position and a locking position.

The second tool container is provided with at least two second locking parts. A number of the second locking parts is identical to that of the at least two first locking parts. The at least two second locking parts are in one-to-one correspondence with the at least two first locking parts.

In any corresponding first locking part and second locking part, when the first locking part is configured in a way that the second tool container is stacked on the first tool container or the first tool container is stacked on the second tool container, the first locking part is capable of being pulled out of the accommodating position. When the first locking part moves to the locking position, the first locking part is at least capable of being turned over to a side where the second tool container is located, and being turned over to the second locking part. The first locking part and the second locking part match to lock the first tool container and the second tool container.

The embodiments of the disclosure have the following beneficial effects: the tool container system provided by the embodiments of the disclosure includes the first tool container and the second tool container that can be stacked. The first tool container is provided with the first locking parts, the second tool container is provided with the second locking parts matched with the first locking parts, the first locking parts are slidably connected to the first tool container, and the first locking parts are accommodated in the first tool container at the accommodating position. When the second tool container is stacked on the first tool container, or when the first tool container is stacked on the second tool container, the first locking parts are pulled out of the accommodating position and then turned over to one side where the second tool container is located, and the first locking parts are turned over to the second locking parts and locked to the second locking parts in a matched manner. The first locking parts and the second locking parts match to lock, thereby the first tool container and the second tool container that are stacked are locked together. According to the tool container system provided by the embodiments of the disclosure, the two stacked tool containers may be stacked first, and then the first locking parts are operated, such that the first locking parts and the second locking parts are locked. In this way, the two stacked tool box containers are locked, and an operation is convenient.

In a possible embodiment, the first tool container is provided with at least two mounting recesses. A number of the at least two mounting recesses is identical to that of the at least two first locking parts. The at least two mounting recesses are in one-to-one correspondence with the at least two first locking parts.

In the first locking part and the mounting recess corresponding to each other, the first locking part is slidably mounted in the mounting recess. When the first locking part is located at the accommodating position, the first locking part is embedded in the mounting recess.

In a possible embodiment, each of the first tool container and the second tool container includes a box body and a cover body for sealing or opening the box body.

Each of the at least two mounting recesses is provided on the cover body of the first tool container.

Each of the at least two second locking parts is arranged on the box body.

When the first tool container and the second tool container are stacked, the second tool container is stacked on the first tool container.

In a possible embodiment, the mounting recesses are provided on edges of the cover bodies. The mounting recesses are in communication with side surfaces of the cover bodies.

When the first locking parts are pulled out from the accommodating position to the locking position, part of the first locking parts extends out of the mounting recesses from through holes between the mounting recesses and the side surfaces of the cover bodies.

In a possible embodiment, two side walls of the each of the mounting recesses in a first direction are provided with chutes. One ends of the chutes closer to the edge of the cover body are provided with blocking side walls.

Two sides of the each of the at least two first locking parts in the first direction are provided with sliding parts. The two sliding parts are placed in the two chutes respectively. The each of the first locking parts slide back and forth in a length direction of the chutes.

In a possible embodiment, an end of each of the chutes closer to the edge of the cover body is provided with a limiting groove. The limiting groove is located at a side of a corresponding chute of the chutes closer to a top surface of the cover body. The limiting groove is in communication with the corresponding chute.

When the limiting groove is configured in a way that the each of the first locking parts and the each of the second locking parts match to lock the first tool container and the second tool container, at least part of each of the sliding parts is located in the limiting groove.

In a possible embodiment, at one ends of the mounting recesses away from the edge of the cover body, two side walls of the mounting recesses in the first direction are provided with avoidance recesses. The avoidance recesses penetrate the chutes and top surface of the cover body. The avoidance recesses are configured to allow the sliding parts to be mounted in the chutes.

In a possible embodiment, the each of the mounting recesses includes a left mounting recess and a right mounting recess. The left mounting recess and the right mounting recess are provided at intervals in the first direction. Two side walls of the left mounting recess and the right mounting recess in the first direction are provided with the chutes.

The each of the first locking parts includes a left mounting part, a right mounting part and a connecting part connecting the left mounting part and the right mounting part. Two sides of the left mounting part and the right mounting part in the first direction are provided with the sliding parts. The left mounting part is slidably mounted in the left mounting recess. The right mounting part is slidably mounted in the right mounting recess.

In a possible embodiment, the second locking parts are clamping plates connected to the box body.

The left mounting part and the right mounting part are provided with hooks.

When the first locking parts and the second locking parts match to lock the first tool container and the second tool container, the hooks of the left mounting part and the hooks of the right mounting part are connected to the clamping plate in a clamped manner.

In a possible embodiment, a bottom of the box body is provided with a grooves corresponding to the first locking parts.

The clamping plate is arranged in the corresponding groove, two ends of the clamping plate are connected to two opposite side walls of the corresponding groove respectively. A reinforcing rib is connected between a middle portion of the clamping plate and a bottom surface of the groove.

The hooks of the left mounting part are connected to the clamping plate located at one side of the reinforcing rib in a clamped manner. The hooks of the right mounting part are connected to the clamping plate located at the other side of the reinforcing rib in a clamped manner.

In a possible embodiment, one ends of the first locking parts slidably connected to the mounting recesses are of arc-shaped structures.

One sides of the first locking parts towards a middle portion of the first tool container are provided with supporting members. When the first locking parts are turned upward to reach an approximately vertical state, the supporting members prevent the first locking parts from being turned over continuously and push the first locking parts to fall back.

In a possible embodiment, the second tool container and the first tool container have an identical structure.

In addition to the technical problems solved by the disclosure, technical features constituting technical solutions and beneficial effects brought by the technical features of the technical solutions, other technical problems solved by the tool container system provided by the disclosure, other technical features included in the technical solutions and beneficial effects brought by the technical features will be further explained in detail in specific embodiments.

### BRIEF DESCRIPTION OF DRAWINGS

The accompanying drawings herein are incorporated in the description as a constitute part of the description, illustrate examples satisfying the disclosure and serve to explain principles of the disclosure together with the description.

FIG. 1 is a schematic diagram of a tool container system according to an embodiment of the disclosure;

FIG. 2 is an enlarged view of A in FIG. 1;

FIG. 3 is a partial enlarged view of a cover body of a first tool container according to an embodiment of the disclosure;

FIG. 4 is a schematic diagram of a first locking part according to an embodiment of the disclosure; and

FIG. 5 is a partial enlarged view of a bottom view of a box body of a second tool container according to an embodiment of the disclosure.

### DESCRIPTION OF REFERENCE NUMERALS

100, first tool container;
110, first locking part; 120, mounting recess; 130, box body; 140, cover body; 150, first side; and 160, second side;
111, sliding part; 112, left mounting part; 113, right mounting part; 114, connecting part; 115, hook; and 116, supporting member;
121, chute; 122, limiting groove; 123, avoidance recess; 124, left mounting recess; and 125, right mounting recess;
200, second tool container;
210, second locking part; and 220, groove; and
211, clamping plate; and 212, reinforcing rib.

Clear examples of the disclosure are shown through the above drawings, and will be described in more details below. The drawings and written description are not intended to limit the scope of the concept of the disclosure in any manner, and are intended to explain the concept of the disclosure to those skilled in the art with reference to specific examples.

### DETAILED DESCRIPTION OF THE INVENTION

In the related art, tool container systems are generally stacked to save space. Moreover, in order to prevent a tool container system located at an upper layer from falling and facilitate transportation of the stacked tool container systems together, a connection locking structure is arranged between stacked objects. In the related art, the connection locking structure generally includes a first locking latch arranged on a first tool container system and a second locking slot arranged on a second tool container system. When not in use, the first locking latch generally lies flat on a cover of the first tool container system. When the second tool container system needs to be stacked on the first tool container system, the first locking latch is turned over, and then the second tool container system is stacked on the first tool container system. However, when the second tool container system is stacked on the first tool container system, a case where the second tool container system knocks over the first locking latch and turns over the first locking latch to the cover, and a case where a user forgets to turn over the first locking latch and directly stacks the second tool container system on the first tool container system possibly exist. In the two cases, the user needs to remove the second tool container system, turn over the first locking latch, and then move the second tool container system to the first tool container system. This process is inconvenient in operation and laborious.

Technical solutions of embodiments of the disclosure will be clearly and completely described below in conjunction with the accompanying drawings of the embodiments of the disclosure. Clearly, the embodiments described are merely some embodiments rather than all embodiments of the disclosure. Based on the embodiments of the disclosure, all other embodiments obtained by those of ordinary skill in the art without making creative efforts fall within the protection scope of the disclosure.

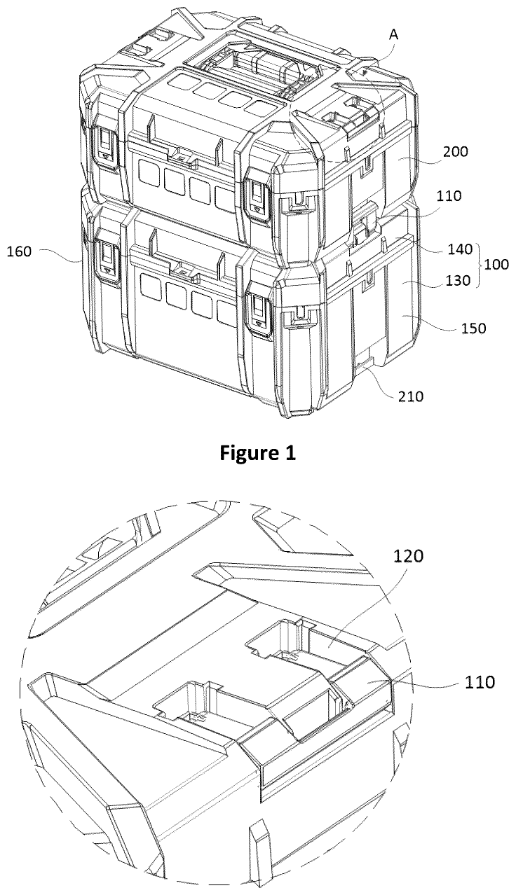

As shown in FIG. 1, a tool container system provided by the embodiment of the disclosure includes a first tool container 100 and a second tool container 200 that may be stacked. The first tool container 100 is provided with at least two first locking parts 110. In all the first locking parts 110, at least one of the first locking parts 110 is arranged at a first side 150 of the first tool container 100, at least one of the first locking parts 110 is arranged at a second side 160 of the first tool container 100, and the first side 150 and the second side 160 are two opposite sides of the first tool container 100. In an embodiment, the first side 150 of the first tool container 100 is provided with one first locking part 110, and the second side 160 of the first tool container 100 is provided with one first locking part 110. In any one of the first locking parts 110, the first locking part 110 is slidably connected to the first tool container 100, and the first locking part 110 is at least capable of sliding between an accommodating position and a locking position.

In the embodiment, the second tool container 200 is provided with at least two second locking parts 210. A number of the second locking parts 210 is identical to that of the first locking parts 110. The second locking parts are in one-to-one correspondence with the first locking parts. In any corresponding first locking part 110 and second locking part 210, the first locking part 110 is configured in such a way that when the second tool container 200 is stacked on the first tool container 100, or when the first tool container 100 is stacked on the second tool container 200, the first locking part 110 is capable of being pulled out of the accommodating position. When the first locking part 110 moves to the locking position, the first locking part is at least capable of being turned over to a side where the second tool container 200 is located, and being turned over to the second locking part 210. The first locking part 110 and the second locking part 210 match to lock the first tool container 100 and the second tool container 200. That is, in the tool container system provided by the embodiment of the disclosure, the first locking part 110 of the tool container is accommodated in the first tool container 100 at the accommodating position. When the two tool containers need to be stacked, the two tool containers can be directly stacked, and then the first locking part 110 is pulled, such that the first locking part 110 is pulled out of the accommodating position and then turned over to a side where the second tool container 200 is located. The first locking part 110 is turned over to the second locking part 210 and locked to the second locking part 210 in a matched manner. The first locking part 110 and the second locking part 210 match to lock, thereby the first tool container 100 and the second tool container 200 that are stacked are locked together. When the tool containers of the tool container system provided by the embodiment of the disclosure are stacked, the first locking parts 110 do not need to be operated in advance, and a problem of influence on tool container stacking when the first locking parts 110 are knocked down in a tool container stacking process is avoided. Operations are convenient and quick.

Further, with reference to FIG. 1, in the embodiment of the disclosure, the second tool container 200 and the first tool container 100 have an identical structure. That is, the first tool container 100 is provided with the second locking parts 210, and the second tool container 200 is provided with the first locking parts 110.

It should be noted that the description that the second tool container 200 and the first tool container 100 have the identical structure means that the first tool container 100 and the second tool container 200 are identical in shape and size. That is, the second tool container 200 is exactly identical to the first tool container 100.

It should be noted that the tool container system provided by the embodiment of the disclosure may further include a third tool container, a fourth tool container, etc. The first tool container 100, the second tool container 200, the third tool container and the fourth tool container may be stacked together. The first tool container 100, the second tool container 200, the third tool container and the fourth tool container all have an identical structure. That is, the tool container system provided by the embodiment of the disclosure includes a plurality of (including two) first tool containers 100. A plurality of tool containers can be stacked, and two adjacent tool containers may be locked together through matching of the first locking parts 110 and the second locking parts 210.

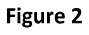

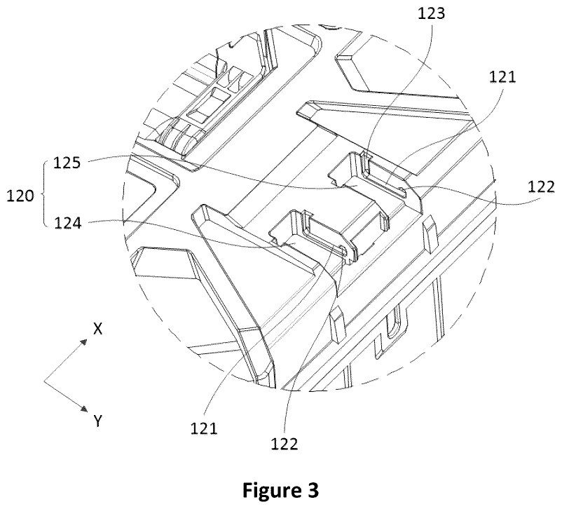

As shown in FIG. 1, FIG. 2, and FIG. 3, the first tool container 100 is provided with at least two mounting recesses 120. A number of the mounting recesses 120 is identical to that of the first locking parts 110. The mounting recesses are in one-to-one correspondence with the first locking parts. In the first locking part 110 and the mounting recess 120 corresponding to each other, the first locking part 110 is slidably mounted in the mounting recess 120. When the first locking part 110 is located at the accommodating position, the first locking part 110 is embedded in the mounting recess 120. The arrangement facilitates a pulling operation of the first locking parts 110. When the first tool container 100 and the second tool container 200 are stacked, the first locking parts 110 are embedded in the mounting recesses 120, such that interference to the pulling operation of the first locking parts 110 is avoided.

In the embodiment, each of the first tool container 100 and the second tool container 200 includes a box body 130 and a cover body 140 for sealing or opening the box body 130. Each of the mounting recesses 120 is provided in the cover body 140. Each of the second locking parts 210 is arranged in the box body 130. When the first tool container 100 and the second tool container 200 are stacked, the second tool container 200 is stacked on the first tool container 100.

As shown in FIG. 3, the mounting recesses 120 are provided on an edge of the cover body 140 of the first tool container 100, and the mounting recesses 120 are in communication with side surface of the cover body 140. When the first locking parts 110 are pulled out from the accommodating position to the locking position, part of each of the first locking parts 110 extends out of a corresponding mounting recess of the mounting recesses 120 from a through hole between the corresponding mounting recess 120 and the side surface of the cover body 140. That is, when the first locking parts 110 are located at the accommodating position, the first locking parts 110 are embedded in the mounting recesses 120 respectively. When the second tool container 200 is stacked on the first tool container 100 and the first locking parts 110 and the second locking parts 210 match to lock the second tool container 200 and the first tool container 100, the first locking parts 110 are pulled out from the through holes between the mounting recesses 120 and the side surfaces of the cover body 140, such that the first locking parts 110 are pulled out. The first locking parts 110 are pulled to the locking position, and then the first locking parts 110 are turned over to a side where the second tool container 200 is located, such that the first locking parts 110 are turned over to the second locking parts 210. The second locking parts 210 and the first locking parts 110 match to lock the second tool container 200 and the first tool container 100.

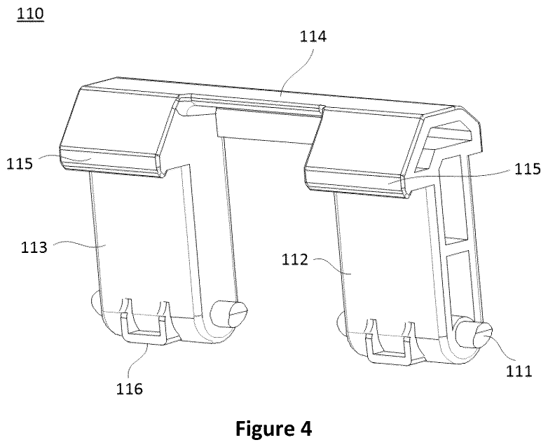

As shown in FIG. 3 and FIG. 4, two side walls of each of the mounting recesses 120 in a first direction (an X direction in FIG. 3) are provided with chutes 121. An end of each of the chutes 121 closer to the edge of the cover body 140 is provided with a blocking side wall. Two sides of the each of the first locking parts 110 in the first direction are provided with sliding parts 111. The two sliding parts 111 are placed in the two chutes 121 respectively. The each of the first locking parts 110 slides back and forth in a length direction of the corresponding chutes 121. The blocking side wall is used for limiting a position of a sliding end of the each of the first locking parts 110 and prevents the first locking part 110 from sliding out of the chutes 121. For example, when the each of the first locking parts 110 slides to the blocking side wall, the each of the first locking parts 110 is located at the locking position.

In order to enhance locking firmness of the first locking parts 110 and the second locking parts 210 and avoid accidental unlocking, an end of each of the chutes 121 closer to the edge of the cover body 140 is provided with a limiting groove 122. The limiting groove 122 is located at a side of the each of the chutes 121 closer to top surface of the cover body 140. The limiting groove 122 is in communication with the corresponding chute 121. The limiting grooves 122 are configured in such a way that when the first locking parts 110 and the second locking parts 210 match to lock the first tool container 100 and the second tool container 200, at least part of the each of the sliding parts 111 is located in a corresponding limiting groove of the limiting grooves 122. That is, when the first locking parts 110 move to the locking position and then are turned and lifted to be locked to the second locking parts 210, the sliding parts 111 of the each of the first locking parts 110 move at least partially from the chutes 121 to the limiting grooves 122, and the limiting grooves 122 limit positions of the sliding parts 111. In this way, the sliding parts 111 cannot move in the length direction of the chutes 121. Thus, the situation that the first locking parts 110 and the second locking parts 210 are unlocked due to the movement of the first locking parts 110 after the first locking parts 110 and the second locking parts 210 are locked is avoided.

In some embodiments, with reference to FIG. 3, in order to facilitate mounting of the sliding parts 111 of the each of the first locking parts 110 in the chutes 121, at one end of the each of the mounting recesses 120 away from the edge of the cover body 140, two side walls of the each of the mounting recesses 120 in the first direction are provided with avoidance recesses 123. The avoidance recesses 123 penetrate the chutes 121 and top surface of the cover body 140. The avoidance recesses 123 are configured to allow the sliding parts 111 to be mounted in the chutes 121. That is, the two sliding parts 111 of the each of the first locking parts 110 are mounted in the chutes 121 from the avoidance recesses 123 on the two side walls of the each of the mounting recesses 120 respectively. The arrangement facilitates mounting of the first locking parts 110.

As shown in FIG. 3 and FIG. 4, the mounting recess 120 includes a left mounting recess 124 and a right mounting recess 125. The left mounting recess 124 and the right mounting recess 125 are provided at intervals in the first direction. Two side walls of the left mounting recess 124 and the right mounting recess 125 in the first direction are provided with the chutes 121.

The first locking part 110 include a left mounting part 112, a right mounting part 113 and a connecting part 114 connecting the left mounting part 112 and the right mounting part 113. Two sides of the left mounting part 112 and the right mounting part 113 in the first direction are provided with the sliding parts 111. The left mounting part 112 is slidably mounted in the left mounting recess 124. The right mounting part 113 is slidably mounted in the right mounting recess 125. That is, the two sliding parts 111 of the left mounting part 112 are mounted in the two chutes 121 of the left mounting recess 124 respectively, and the two sliding parts 111 of the right mounting part 113 are mounted in the two chutes 121 of the right mounting recess 125 respectively. The arrangement can improve strength of connection between the each first locking part 110 and the first tool container 100. When the first locking parts 110 and the second locking parts 210 are locked, the each of the first locking parts 110 is connected to the first tool container 100 through the two sliding parts 111 of the left mounting part 112 and the two sliding parts 111 of the right mounting part 113. Strength borne by the four sliding parts 111 is greater than that borne by the two sliding parts 111.

It should be noted that in some embodiments of the disclosure, the mounting recess 120 may be a single-recess. That is, only the two opposite sides of the first locking part 110 are provided with the sliding parts 111, and the two sliding parts 111 are mounted in the chutes 121 on the two opposite side walls of the mounting recess 120. Clearly, structures of the mounting recess 120 may be the double-recess as shown in FIG. 3.

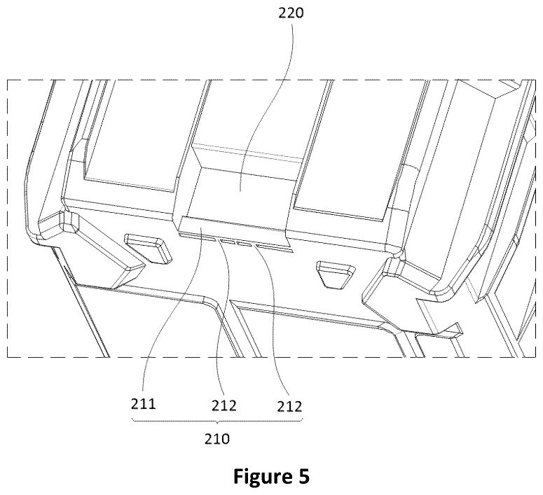

As shown in FIG. 1, FIG. 4, and FIG. 5, in some embodiments, each of the second locking parts 210 is a clamping plate 211 connected to the box body 130. The left mounting part 112 and the right mounting part 113 are provided with hooks 115. When the first locking parts 110 and the second locking parts 210 match to lock the first tool container 100 and the second tool container 200, the hook 115 of the left mounting part 112 and the hook 115 of the right mounting part 113 are connected to the clamping plate 211 in a clamped manner.

In some embodiments, a bottom of the box body 130 is provided with a groove 220 corresponding to the first locking part 110. The clamping plate 211 is arranged in the groove 220, and two ends of the clamping plate 211 are connected to two opposite side walls of the groove 220 respectively. Reinforcing ribs 212 are connected between a middle portion of the clamping plate 211 and a bottom surface of the groove 220. The hook 115 of the left mounting part 112 is connected to the clamping plate 211 located at one side of the reinforcing rib 212 in a clamped manner. The hook 115 of the right mounting part 113 is connected to the clamping plate 211 located at the other side of the reinforcing rib 212 in a clamped manner. The arrangement can increase strength of the clamping plate 211. The first locking part 110 is divided into the left mounting part 112 and the right mounting part 113 that are connected to two sides of zones where the clamping plates 211 are provided with the reinforcing ribs 212 in a clamped manner respectively. The arrangement enables the reinforcing ribs 212 of the clamping plate 211 to extend to a top of the clamping plate 211 without interfering with clamping of the first locking part 110 and the clamping plate 211. In this way, strength of the clamping plate 211 is increased, clamping firmness of the first locking part 110 and the clamping plate 211 is increased, and a problem of poor snap fit between the first locking part 110 and the clamping plate 211 caused by deformation of the clamping plate 211 is avoided.

In some embodiments of the disclosure, as shown in FIG. 4, one end of the first locking part 110 slidably connected to the mounting recess 120 is of arc-shaped structures. One side of the first locking part 110 towards a middle portion of the first tool container 100 is provided with supporting members 116. When the first locking part 110 is turned upward to reach an approximately vertical state, the supporting members 116 prevent the first locking part 110 from being turned over continuously and push the first locking part 110 to fall back. The arrangement can avoid a problem of influence on an operation of stacking the second tool container 200 on the first tool container 100 when the first locking part 110 is formed in an approximately perpendicular state or turned over to an upper portion of the first tool container 100.

Those skilled in the art could easily conceive of other implementation solutions of the disclosure upon consideration of the description and the invention disclosed herein. The disclosure is intended to cover any variations, uses or adaptive changes of the disclosure, which follow general principles of the disclosure and include common general knowledge or conventional technical means, not disclosed in the disclosure, in the art. The description and the embodiments are regarded as illustrative only, and the true scope and spirit of the disclosure are indicated by the following claims.

It should be understood that the disclosure is not limited to a precise structure described above and illustrated in the accompanying drawings, and can have various modifications and changes without departing from the its scope. The scope of the disclosure is limited by the appended claims only.

1. A tool container system, comprising a first tool container and a second tool container, wherein
the first tool container is provided with at least two first locking parts, in the at least two first locking parts, at least one of the at least two first locking parts is arranged at a first side of the first tool container, at least one of the at least two first locking parts is arranged at a second side of the first tool container, and the first side and the second side are two opposite sides of the first tool container; and in any one of the at least two first locking parts, each of the first locking parts is slidably connected to the first tool container, and the each of the first locking parts is at least capable of sliding between an accommodating position and a locking position;
the second tool container is provided with at least two second locking parts, a number of the at least two second locking parts is identical to that of the at least two first locking parts, and the at least two second locking parts are in one-to-one correspondence with the at least two first locking parts; and
in any corresponding first locking part and second locking part, when the first locking part is configured in a way that the second tool container is stacked on the first tool container or the first tool container is stacked on the second tool container, the first locking part is capable of being pulled out of the accommodating position, when the first locking part moves to the locking position, the first locking part is at least capable of being turned over to a side where the second tool container is located, and being turned over to the second locking part, and the first locking part and the second locking part match to lock the first tool container and the second tool container.

2. The tool container system according to claim 1, wherein the first tool container is provided with at least two mounting recesses, a number of the at least two mounting recesses is identical to that of the at least two first locking parts, and the at least two mounting recesses are in one-to-one correspondence with the at least two first locking parts; and
in a first locking part and a mounting recess corresponding to each other, the first locking part is slidably mounted in the mounting recess, and when the first locking part is located at the accommodating position, the first locking part is embedded in the mounting recess.

3. The tool container system according to claim 2, wherein each of the first tool container and the second tool container comprises a box body and a cover body for sealing or opening the box body;
each of the at least two mounting recesses is provided on the cover body of the first tool container;
each of the at least two second locking parts is arranged on the box body; and
when the first tool container and the second tool container are stacked, the second tool container is stacked on the first tool container.

4. The tool container system according to claim 3, wherein the each of at least two mounting recesses is provided on an edge of the cover body of the first tool container, and the each of the at least two mounting recesses is in communication with a side surface of the cover body; and
when each of the at least two first locking parts is pulled out from the accommodating position to the locking position, part of the each of the first locking parts extends out of a corresponding mounting recess in the at least two mounting recesses from a through hole between the corresponding mounting recess and the side surface of the cover body.

5. The tool container system according to claim 4, wherein two side walls of the each of the at least two mounting recesses in a first direction are provided with chutes, and ends of the chutes closer to the edge of the cover body are provided with blocking side walls; and
two sides of the each of the at least two first locking parts in the first direction are provided with sliding parts, the two sliding parts are placed in the two chutes respectively, and the each of the first locking parts slide back and forth in a length direction of the two chutes.

6. The tool container system according to claim 5, wherein an end of each of the chutes closer to the edge of the cover body is provided with a limiting groove, the limiting groove is located at a side of a corresponding chute of the chutes closer to a top surface of the cover body, and the limiting groove is in communication with the corresponding chute; and
when the limiting groove is configured in a way that the each of the first locking parts and the each of the second locking parts match to lock the first tool container and the second tool container, at least part of each of the sliding parts is located in the limiting groove.

7. The tool container system according to claim 5, wherein at one end of the each of the mounting recesses away from the edge of the cover body, two side walls of the each of the mounting recesses in the first direction are provided with avoidance recesses, each of the avoidance recesses penetrates a corresponding chute of the chutes and a top surface of the cover body, and the each of the avoidance recesses is configured to allow a corresponding sliding part of the sliding parts to be mounted in the corresponding chute.

8. The tool container system according to claim 5, wherein the each of the mounting recesses comprises a left mounting recess and a right mounting recess, the left mounting recess and the right mounting recess are provided at intervals in the first direction, and two side walls of the left mounting recess and the right mounting recess in the first direction are provided with the chutes; and
each of the first locking parts comprises a left mounting part, a right mounting part and a connecting part connecting the left mounting part and the right mounting part; and two sides of the left mounting part and the right mounting part in the first direction are provided with the sliding parts, the left mounting part is slidably mounted in the left mounting recess, and the right mounting part is slidably mounted in the right mounting recess.

9. The tool container system according to claim 8, wherein the each of the second locking parts is a clamping plate connected to the box body;
the left mounting part and the right mounting part are provided with hooks; and
when the first locking parts and the second locking parts match to lock the first tool container and the second tool container, the hooks of the left mounting part and the hooks of the right mounting part are connected to the clamping plate in a clamped manner.

10. The tool container system according to claim 9, wherein a bottom of the box body is provided with a groove corresponding to a corresponding first locking part in the first locking parts;
the clamping plate is arranged in the groove, two ends of the clamping plate are connected to two opposite side walls of the groove respectively, and a reinforcing rib is connected between a middle portion of the clamping plate and a bottom surface of the groove; and
the hooks of the left mounting part are connected to the clamping plate located at one side of the reinforcing rib in a clamped manner, and the hooks of the right mounting part are connected to the clamping plate located at the other sides of the reinforcing rib in a clamped manner.

11. The tool container system according to claim 4, wherein ends of the first locking parts slidably connected to the mounting recesses are of arc-shaped structures; and
a side of the each of the at least two first locking parts towards a middle portion of the first tool container is provided with a supporting member.

12. The tool container system according to claim 1, wherein the second tool container and the first tool container have an identical structure.

13. The tool container system according to claim 5, wherein ends of the first locking parts slidably connected to the mounting recesses are of arc-shaped structures; and
a side of the each of the at least two first locking parts towards a middle portion of the first tool container is provided with a supporting member.

14. The tool container system according to claim 6, wherein ends of the first locking parts slidably connected to the mounting recesses are of arc-shaped structures; and
a side of the each of the at least two first locking parts towards a middle portion of the first tool container is provided with a supporting member.

15. The tool container system according to claim 7, wherein ends of the first locking parts slidably connected to the mounting recesses are of arc-shaped structures; and
a side of the each of the at least two first locking parts towards a middle portion of the first tool container is provided with a supporting member.

16. The tool container system according to claim 8, wherein ends of the first locking parts slidably connected to the mounting recesses are of arc-shaped structures; and
a side of the each of the at least two first locking parts towards a middle portion of the first tool container is provided with a supporting member.

17. The tool container system according to claim 9, wherein ends of the first locking parts slidably connected to the mounting recesses are of arc-shaped structures; and
a side of the each of the at least two first locking parts towards a middle portion of the first tool container is provided with a supporting member.

18. The tool container system according to claim 10, wherein ends of the first locking parts slidably connected to the mounting recesses are of arc-shaped structures; and
a side of the each of the at least two first locking parts towards a middle portion of the first tool container is provided with a supporting member.
